(19) United States
(12) Patent Application Publication
(10) Pub. No.: US 2026/0199187 A1
(43) Pub. Date: Jul. 16, 2026

(54) PHARMACEUTICAL PREPARATION DEVICE UTILIZING IMAGING-ENHANCED PREPARATION PROCESS COMPONENT PLACEMENT

(71) Applicant: EQUASHIELD MEDICAL LTD, Migdal Tefen (IL)

(72) Inventors: Marino KRIHELI, Savion (IL); Osnat PERRY, Harduf (IL); Boaz SLAV, Haifa (IL)

(21) Appl. No.: 19/135,198

(22) PCT Filed: Dec. 4, 2023
(86) PCT No.: PCT/IL2023/051242

§ 371 Date: Jun. 3, 2025

Related U.S. Application Data
(60) Provisional application No. 63/430,037, filed on Dec. 4, 2022.

(51) Int. Cl. A61J 1/16; A61J 1/20; B25J 9/16; G06T 7/20; G06T 7/80; G06V 20/52

(52) U.S. Cl. CPC A61J 1/16; A61J 1/2096; B25J 9/1692; B25J 9/1697; G06T 7/20; G06T 7/80; G06V 20/52; G06V 2201/06

(57) ABSTRACT

Some embodiments relate to a pharmaceutical preparation device (PPD) with imaging-enhanced preparation process component placement, including a camera configured to capture images of a pharmaceutical preparation interconnection location (PPIL), from a PPIL camera location, the PPIL being associated with a precalibration data; a transport unit (TU) including a gripper for grasping a pharmaceutical compounding component, the TU being configured to move the gripper in one or more of x, y, and/or z directions in response to control signals; and a processing circuitry operably connected to the TU and to the camera. The processing circuitry can be configured to receive at least one real-time digital image, captured by the camera from the PPIL camera location; determine direction and distance of TU movement based on at least the received real-time digital image and the precalibration data; and control the TU to move the gripper in the determined direction by the determined distance.

### CROSS-REFERENCE TO RELATED APPLICATIONS

This application is a national phase filing under 35 C.F.R. § 371 of and claims priority to PCT Patent Application No. PCT/IL2023/051242, filed on Dec. 4, 2023, which claims the priority benefit under 35 U.S.C. § 119 of U.S. Provisional Patent Application No. 63/430,037, filed on Dec. 4, 2022, the contents of which are hereby incorporated in their entireties by reference.

### TECHNICAL FIELD

The presently disclosed subject matter relates to devices of robotic preparation of pharmaceuticals and movements of components within such devices, and in particular to imaging-enhanced placement of such components.

### BACKGROUND

Problems of implementation of automation of pharmaceutical preparation have been recognized in the conventional art and various techniques have been developed to provide solutions. Some solutions include automatic or semi-automatic pharmaceutical preparation devices and systems for preparing drugs designated for administration to patients. These devices and systems include fluid transfer stations for transfer of fluid between pharmaceutical compounding components, and robotic arms to grasp and move the pharmaceutical compounding components between the stations.

### GENERAL DESCRIPTION

The presently disclosed subject matter generally relates to robotic pharmaceutical preparation devices and/or systems. The robotic pharmaceutical preparation devices and the fluid transfer stations thereof are configured for performing the operations related to transfer of drugs between different pharmaceutical compounding components (or preparation process components) including containers, fluid transfer assemblies, connectors, conduits, pumps, syringes, vials, intravenous bags, adaptors, needles, ampules, etc. The robotic pharmaceutical preparation devices (or robotic devices) according to the presently disclosed subject matter include robotic stations, robotic arms, motors, control units (controllers), mechanisms, transfer units, manipulators to move the pharmaceutical compounding components relative to each other and to control the transfer of fluid therebetween. The robotic pharmaceutical preparation device can be operable for performing any activity related to preparation of drugs, such as drugs designated for administration to patients, including, for example, compounding, diluting, reconstituting, transferring, filling, drawing, agitating and/or other processes associated with pharmaceutical preparation.

The robotic pharmaceutical preparation device is configured for receiving and optionally manipulating various types of containers, such as drug vials, intravenous (IV) bags, syringes, tubes, elastomeric pumps, and/or other containers suitable for holding and/or transferring fluid and/or powder. In some examples, the robotic pharmaceutical preparation device is configured for receiving at least one drug vial; diluting or reconstituting the drug in the vial, as needed; optionally, agitating the vial; and then obtaining, by drawing from the vial, a defined amount of the ready drug. In some cases, the drug is then prepared for administration to a patient, for example by transferring the drug into a syringe, an elastomeric pump, an IV bag, or any other suitable container.

The pharmaceutical preparation device may be deployed for preparation of any type of drug, including a hazardous drug which is prepared in closed systems, as well as non-hazardous drugs. In closed fluid transfer devices or systems deployed for preparation of hazardous pharmaceuticals or drugs, measures are taken to prevent hazardous leakage of fluid and/or fume from the containers and/or further for prevention of infiltration of contaminates into the drug. For ensuring sterility, alignment of containers and providing a secured coupling during fluid transfer, connectors or adaptors can be used with the containers and/or generally used at fluid transfer interfaces of the device.

The pharmaceutical preparation device according to the presently disclosed subject matter utilizes imaging-enhanced preparation process component placement to ensure alignment of the preparation process components or pharmaceutical compounding components with each other prior to and during the transfer of fluid (drug) therebetween. It is to be understood herein that for the purposes of the present description, any two containers between which transfer of fluid is to take place has been referred to as preparation process components or pharmaceutical compounding components, and their placement and/or alignment with respect to the device and/or each other is enhanced.

There is provided in accordance with a first aspect of the presently disclosed subject matter, for example, a pharmaceutical preparation device with imaging-enhanced preparation process component placement, comprising: a camera configured to capture images of a pharmaceutical preparation interconnection location (PPIL), from a PPIL camera location, said PPIL being associated with a precalibration data; a transport unit (TU) comprising a gripper for grasping a pharmaceutical compounding component, the TU being configured to move at least the gripper in one or more of x, y, and/or z directions in response to control signals; and a processing circuitry operably connected to the TU and to the camera, the processing circuitry being configured to: receive at least one real-time digital image, captured by the camera from the PPIL camera location, the received digital image depicting the gripper of the TU and/or a pharmaceutical compounding component grasped by the gripper, in a current position in the PPIL; determine a direction and distance of TU movement based on at least the received real-time digital image and the precalibration data; and control, via the control signals, the TU to move the gripper in the determined direction by the determined distance.

For the purposes of the present description, it is to be understood herein that “pharmaceutical preparation interconnection location (PPIL)” includes a location, within a camera view of the camera, at which a gripper of the TU and/or a pharmaceutical compounding component grasped by the gripper is positioned for the establishment of interconnection between the pharmaceutical compounding component and another pharmaceutical compounding component, between their respective connectors, or between a pharmaceutical compounding component and its connector. The camera view of the camera being the camera view when the camera is positioned at a particular location, referred to herein as PPIL camera location in the device.

For the purposes of the present description, it is to be further understood herein that “transport unit” includes a mechanism to grasp, hold and move any pharmaceutical compounding component within the device including a manipulator in the form of a robotic arm, a platform, a robotic station, or the like having holders to hold the components and move them relatively to each other and perform the transfer of fluid. The manipulator can be a fluid transfer assembly manipulator, for example a syringe manipulator, or a container manipulator, for example a vial manipulator or an IV bag manipulator.

For the purposes of the present description, it is to be further understood herein that “gripper” includes a mechanism to grasp, hold, or otherwise engage a pharmaceutical compounding component. The gripper can be a gripping arm of a fluid transfer assembly manipulator, a vial holder, an IV bag holder, and any other suitable mechanism to hold any pharmaceutical compounding component. The gripper can hold the pharmaceutical compounding component from any portion thereof including a body or a connector/adaptor connected thereto.

For the purposes of the present description, it is to be further understood herein that “pharmaceutical compounding component” includes any container being a component of a fluid transfer apparatus with or without an adaptor or connector for establishing fluid communication of the container with other containers. For example, the container can constitute a container assembly having the container along with a container connector (or adaptor) for establishing the fluid communication of the container with other containers. For example, the container can be a vial along with a vial adaptor, or an intravenous bag along with a spike adaptor, or a syringe along with a syringe adaptor. For example, the container can be one or more of: syringe, IV bag, elastomeric pump, vial, bottle, ampule, or generally any vessel or receptacle suitable for holding fluids or liquids. The container can be accessible via a container septum which can be a septum of the container lid, container port, or can be a part of the connector.

For the purposes of the present description, it is to be further understood herein that “precalibration data” includes one or more images and/or processing data obtained upon image processing of one or more images of the PPIL, which is used by the processing circuitry along with an information about a desired position (also referred to herein as calibrated position) of the gripper and/or the pharmaceutical compounding component grasped by the gripper to determine the required movement of the gripper for bringing the gripper and/or the pharmaceutical compounding component grasped by the gripper to the desired position from a current (real-time) position in the PPIL. The precalibration data is collected before the actual real-time use of the device, and is stored in the memory. During the real-time use of the device, the precalibrated data is used by the processing circuitry to determine whether the gripper and/or the pharmaceutical compounding component is in the desired position or not, and if not then generate control signals for the transfer unit to move the gripper from its current position to the desired position.

For the purposes of the present description, it is to be understood herein that the desired position represents a position in the PPIL where the gripper and/or the pharmaceutical compounding component is intended to be positioned for interconnection with another container and/or transfer of drug is to be performed, or where the gripper is intended to be positioned for grasping the pharmaceutical compounding component. Further, the current position represents a position in the PPIL where the gripper and/or the pharmaceutical compounding component is currently, i.e., in real-time or during use of the device for performing an operation related to moving and positioning the gripper, are positioned when the real-time image(s) is captured by the camera from the PPIL location.

In some cases, the precalibration data can include two-dimensional (2D) or three-dimensional (3D) precalibration image(s) depicting the gripper and/or a pharmaceutical compounding component grasped by the gripper, in a calibrated position (also referred to herein as desired position), as captured by the camera from the PPIL camera location. Once the real-time image(s) of the PPIL during use of the device is obtained, the processing circuitry, based on the precalibration image(s) and the real-time image(s), determines whether the gripper and/or the pharmaceutical compounding component is in the desired position or not, and if not then generate control signals for the transfer unit to move the gripper from its current position to the desired position. The control signals can be generated based on comparison of the precalibration image(s) and the real-time image(s) and thereby determining a pixel shift between the current position and the calibrated position. Further, based on the pixel shift, direction and distance of a TU movement is determined. The direction and distance of the TU movement represent the direction and distance that the TU needs to move the gripper to position the gripper and/or the pharmaceutical compounding component in the desired position thereof.

In some cases, the precalibration data can include a calibration transformation matrix which is derivative of a calibration process utilizing at least three images depicting the gripper of the TU and/or the pharmaceutical compounding component grasped by the gripper from the PPIL camera location, the calibration transformation matrix being adapted to convert x, y, and/or z coordinates of an image to corresponding coordinates in a transport unit frame-of-reference.

It is to be understood herein that the transport unit is in a particular location and is controlled by a controller to move the transport unit (or gripper thereof) by various distances in the x, y, and z directions. These distances are coordinates of the transport unit frame-of-reference.

In some examples, the processing circuitry is configured to perform the calibration process to derive the calibration transformation matrix. The calibration process includes receiving at least three images of the PPIL as captured by the camera from the PPIL camera location, each image depicting the gripper and/or the pharmaceutical compounding component held by the gripper. In some examples, the images can be 2D images and the calibration process includes receiving at least three images. In some examples, the images can be 3D images and the calibration process includes receiving at least four images. Each image is associated with an x coordinate, y coordinate, and z coordinate, in the transport unit frame-of-reference, corresponding to a given point on the gripper or the pharmaceutical compounding component held by the gripper. These x, y, and z coordinates can be obtained as follows:
place the gripper and/or the pharmaceutical compounding component held by the gripper in a particular location in the PPIL
the processing circuitry receives an image of the gripper and/or the pharmaceutical compounding component held by the gripper and the PPIL; and
the processing circuitry also receives, from the TU, the information that the gripper and/or the pharmaceutical compounding component held by the gripper is now located at x1, y1, and z1.

The processing circuitry performs the calibration process, thereby resulting in data indicative of the calibration transformation matrix, which is adapted to convert x, y, and z coordinates of an image to corresponding coordinates in the transport unit frame-of-reference.

In some examples, the precalibration data can also include the desired position of the gripper and/or the pharmaceutical compounding component in the PPIL, in the transport unit frame of reference (TUFoR), and accordingly, the processing circuitry can have the desired coordinates (in the TUFoR), i.e., the coordinates of position where the gripper and/or the pharmaceutical compounding component is required/desired to be positioned. In some examples, the desired coordinates (in the TUFoR), i.e., the coordinates of position where the gripper and/or the pharmaceutical compounding component is required/desired to be positioned can be received by the processing circuitry from an external source.

During the real-time use of the device, a real-time digital image depicting the PPIL and the gripper or the pharmaceutical compounding component being held by the gripper, at its current position, is captured by the camera from the PPIL location and is received by the processing circuitry. The processing circuitry applies the calibration transformation matrix to the received real-time digital image to determine the direction and distance of TU movement, which represents the direction and distance that the TU needs to move the gripper to position the gripper and/or the pharmaceutical compounding component in the desired position thereof. The processing circuitry applying the calibration transformation matrix to the received real-time digital image includes identifying, in the received image, x, y, and z coordinates of the given point on the gripper or the pharmaceutical compounding component being held by the gripper and transforming, using the calibration transformation matrix, the x, y, and z coordinates identified in the received image to x, y, and z coordinates in the transport unit frame-of-reference. The processing circuitry determines the direction/distance of the TU movement by comparing the post-transformation x, y, z coordinates to the desired coordinates (in the TU Frame-of-reference).

In some examples, the processing circuitry can be further configured to utilize an identification information for determining the direction/distance of the TU movement to position the gripper and/or the pharmaceutical compounding component in the desired position. The identification information can be related to identification of one or more of the gripper, the pharmaceutical compounding component being grasped by the gripper, another pharmaceutical compounding component that the interconnection of the pharmaceutical compounding component is to be established with, or the pharmaceutical compounding component that is to be grasped by the gripper. It is to be understood herein that the identification information can be determined by the processing circuitry, for example by image processing, or can be received from an external source.

In some examples, the processing circuitry can be further configured to control the gripper of the TU to perform at least one of:
grasping a pharmaceutical compounding component;
releasing a pharmaceutical compounding component that the gripper is grasping; and
establishing a fluid communication between a pharmaceutical compounding component that the gripper is grasping and a second pharmaceutical compounding component.

There is provided in accordance with a second aspect of the presently disclosed subject matter, for example, a processing circuitry-based method of imaging-enhanced preparation process component placement in a pharmaceutical preparation device (PPD), the method comprising: utilizing a transport unit (TU) configured to move at least a gripper thereof in one or more of x, y, and/or z directions in response to control signals; utilizing precalibration data; receiving at least one real-time digital image, of a pharmaceutical preparation interconnection location (PPIL) captured by a camera positioned at a PPIL camera location, the received digital image depicting the gripper of the TU and/or a pharmaceutical compounding component grasped by the gripper, in a current position; determining a direction and distance of TU movement, based on, at least the received real-time digital image and the precalibration data; and controlling the TU to move the gripper in the determined direction by the determined distance.

There is provided in accordance with a third aspect of the presently disclosed subject matter, for example, computer program product comprising a computer readable non-transitory storage medium containing program instructions, which program instructions when read by a processor, cause the processing circuitry to perform a method of imaging-enhanced preparation process component placement in a pharmaceutical preparation device (PPD), the method comprising: utilizing a transport unit (TU) configured to move at least a gripper thereof in one or more of x, y, and/or z directions in response to control signals; utilizing precalibration data; receiving at least one real-time digital image, of a pharmaceutical preparation interconnection location (PPIL) captured by a camera positioned at the PPIL camera location, the received digital image depicting the gripper of the TU and/or a pharmaceutical compounding component grasped by the gripper, in a current position; determining a direction and distance of TU movement, based on, at least the received real-time digital image and the precalibration data; and controlling the TU to move the gripper in the determined direction by the determined distance.

In some examples, in any one of the second and third aspect, the precalibration data can include a two-dimensional (2D) or three-dimensional (3D) precalibration image depicting the gripper of the TU and/or a pharmaceutical compounding component grasped by the gripper of the TU, in a calibrated position, as captured by the camera from the PPIL camera location.

In some examples, in any one of the second and third aspect, the method can further comprise, prior to determining the direction and distance of TU movement, determining that there is a pixel shift between the current position and the calibrated position. In some examples, in any one of the second and third aspect, the method can comprise determining the direction and distance of TU movement based at least on the pixel shift.

In some examples, in any one of the second and third aspect, the precalibration data can include a calibration transformation matrix which is derivative of a calibration process utilizing at least three images depicting the gripper of the TU and/or the pharmaceutical compounding component grasped by the gripper from the PPIL camera location, the calibration transformation matrix being adapted to convert x, y, and/or z coordinates of an image to corresponding coordinates in a transport unit frame-of-reference. The method can comprise determining the direction and distance of TU movement at least by applying the calibration transformation matrix to the received real-time digital image. In some examples, in any one of the second and third aspect, the method can comprise performing the calibration process.

It is to be understood herein that the description of the components and features of the pharmaceutical preparation device of the first aspect provided above applies analogously to the corresponding components and features included in the method of the second aspect and the computer program product of the third aspect.

### EMBODIMENTS

A more specific description is provided in the Detailed Description whilst the following are non-limiting examples of different embodiments of the presently disclosed subject matter.

1. A pharmaceutical preparation device (PPD) with imaging-enhanced preparation process component placement, comprising:
a camera configured to capture images of a pharmaceutical preparation interconnection location (PPIL), from a PPIL camera location, said PPIL being associated with a precalibration data;
a transport unit (TU) comprising a gripper for grasping a pharmaceutical compounding component, the TU being configured to move at least the gripper in one or more of x, y, and/or z directions in response to control signals; and
a processing circuitry operably connected to the TU and to the camera, the processing circuitry being configured to:
   receive at least one real-time digital image, captured by the camera from the PPIL camera location, the received digital image depicting the gripper of the TU and/or a pharmaceutical compounding component grasped by the gripper, in a current position in the PPIL;
   determine a direction and distance of TU movement based on at least the received real-time digital image and the precalibration data; and
   control, via the control signals, the TU to move the gripper in the determined direction by the determined distance.

2. The PPD of embodiment 1, wherein the received digital image is two-dimensional (2D), and wherein the determined direction comprises x direction and/or z direction.

3. The PPD of embodiment 1, wherein the received digital image is three-dimensional (3D), and wherein the determined direction comprises x direction, y direction, and/or z direction.

4. The PPD of any one of embodiments 1 to 3, wherein the precalibration data includes a two-dimensional (2D) or three-dimensional (3D) precalibration image depicting the gripper of the TU and/or a pharmaceutical compounding component grasped by the gripper of the TU, in a calibrated position, as captured by the camera from the PPIL camera location.

5 The PPD of embodiment 4, wherein the processing circuitry is further configured to, prior to determining the direction and distance of TU movement, determine that there is a pixel shift between the current position and the calibrated position.

6. The PPD of embodiment 5, wherein the processing circuitry is configured to determine the direction and distance of TU movement based at least on the pixel shift.

7. The PPD of any one of embodiments 1 to 3, wherein the precalibration data includes a calibration transformation matrix which is derivative of a calibration process utilizing at least three images depicting the gripper of the TU and/or the pharmaceutical compounding component grasped by the gripper from the PPIL camera location, the calibration transformation matrix being adapted to convert x, y, and/or z coordinates of an image to corresponding coordinates in a transport unit frame-of-reference.

8. The PPD of embodiment 7, wherein the processing circuitry is configured to determine the direction and distance of TU movement at least by applying the calibration transformation matrix to the received real-time digital image.

9. The PPD of embodiment 7 or 8, wherein the received digital image is two-dimensional (2D), and the precalibration data includes a calibration transformation matrix which is derivative of a calibration process utilizing at least three images depicting the gripper of the TU and/or the pharmaceutical compounding component grasped by the gripper from the PPIL camera location.

10. The PPD of embodiment 7 or 8, wherein the received digital image is three-dimensional (3D), and the precalibration data includes a calibration transformation matrix which is derivative of a calibration process utilizing at least four images depicting the gripper of the TU and/or the pharmaceutical compounding component grasped by the gripper from the PPIL camera location.

11. The PPD of any one of embodiments 7 to 10, wherein the processing circuitry is configured to perform said calibration process.

12. The PPD of any one of embodiments 1 to 11, wherein the processing circuitry is further configured to control the gripper of the TU to perform at least one of:
grasping a pharmaceutical compounding component;
releasing a pharmaceutical compounding component that the gripper is grasping; and
establishing a fluid communication between a pharmaceutical compounding component that the gripper is grasping and a second pharmaceutical compounding component.

13. A processing circuitry-based method of imaging-enhanced preparation process component placement in a pharmaceutical preparation device (PPD), the method comprising:
utilizing a transport unit (TU) configured to move at least a gripper thereof in one or more of x, y, and/or z directions in response to control signals;
utilizing precalibration data;
receiving at least one real-time digital image, of a pharmaceutical preparation interconnection location (PPIL) captured by a camera positioned at a PPIL camera location, the received digital image depicting the gripper of the TU and/or a pharmaceutical compounding component grasped by the gripper, in a current position;
determining a direction and distance of TU movement, based on, at least the received real-time digital image and the precalibration data; and
controlling the TU to move the gripper in the determined direction by the determined distance.

14. The method of embodiment 13, wherein the precalibration data includes a two-dimensional (2D) or three-dimensional (3D) precalibration image depicting the gripper of the TU and/or a pharmaceutical compounding component grasped by the gripper of the TU, in a calibrated position, as captured by the camera from the PPIL camera location.

15. The method of embodiment 14, further comprises, prior to determining the direction and distance of TU movement, determining that there is a pixel shift between the current position and the calibrated position.

16. The method of embodiment 15, comprises determining the direction and distance of TU movement based at least on the pixel shift.

17. The method of embodiment 13, wherein the precalibration data includes a calibration transformation matrix which is derivative of a calibration process utilizing at least three images depicting the gripper of the TU and/or the pharmaceutical compounding component grasped by the gripper from the PPIL camera location, the calibration transformation matrix being adapted to convert x, y, and/or z coordinates of an image to corresponding coordinates in a transport unit frame-of-reference.

18. The method of embodiment 17, comprises determining the direction and distance of TU movement at least by applying the calibration transformation matrix to the received real-time digital image.

19. The method of embodiment 18, further comprises performing said calibration process.

20. A computer program product comprising a computer readable non-transitory storage medium containing program instructions, which program instructions when read by a processor, cause the processing circuitry to perform a method of imaging-enhanced preparation process component placement in a pharmaceutical preparation device (PPD), the method comprising:
utilizing a transport unit (TU) configured to move at least a gripper thereof in one or more of x, y, and/or z directions in response to control signals;
utilizing precalibration data;
receiving at least one real-time digital image, of a pharmaceutical preparation interconnection location (PPIL) captured by a camera positioned at the PPIL camera location, the received digital image depicting the gripper of the TU and/or a pharmaceutical compounding component grasped by the gripper, in a current position;
determining a direction and distance of TU movement, based on, at least the received real-time digital image and the precalibration data; and
controlling the TU to move the gripper in the determined direction by the determined distance.

21. The computer program product of embodiment 20, wherein the precalibration data includes a two-dimensional (2D) or three-dimensional (3D) precalibration image depicting the gripper of the TU and/or a pharmaceutical compounding component grasped by the gripper of the TU, in a calibrated position, as captured by the camera from the PPIL camera location.

22. The computer program product of embodiment 21, wherein the method further comprises, prior to determining the direction and distance of TU movement, determining that there is a pixel shift between the current position and the calibrated position.

23. The computer program product of embodiment 22, wherein the method further comprises determining the direction and distance of TU movement based at least on the pixel shift.

24. The computer program product of embodiment 20, wherein the precalibration data includes a calibration transformation matrix which is derivative of a calibration process utilizing at least three images depicting the gripper of the TU and/or the pharmaceutical compounding component grasped by the gripper from the PPIL camera location, the calibration transformation matrix being adapted to convert x, y, and/or z coordinates of an image to corresponding coordinates in a transport unit frame-of-reference.

25. The computer program product of embodiment 24, wherein the method comprises determining the direction and distance of TU movement at least by applying the calibration transformation matrix to the received real-time digital image.

26. The computer program product of embodiment 24, wherein the method further comprises performing said calibration process.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A illustrates a perspective view of a portion of a pharmaceutical preparation device (PPD), in accordance with an example of the subject matter of the presently disclosed subject matter;

FIG. 1B illustrates a side view of a portion of the pharmaceutical preparation device (PPD) of FIG. 1A;

FIG. 1C schematically illustrates a pharmaceutical compounding component and another container, in accordance with an example of the subject matter of the presently disclosed subject matter;

FIG. 2 schematically illustrates a portion of a pharmaceutical preparation device showing Preparation Process Interconnection Locations and cameras positioned at PPIL camera locations;

FIGS. 3A to 3C schematically illustrate an example sequence of positioning of a pharmaceutical compounding component, in accordance with an example of the subject matter of the presently disclosed subject matter;

FIGS. 3D and 3E illustrate a portion of a pharmaceutical preparation device depicting an example sequence of positioning of a pharmaceutical compounding component, in accordance with an example of the subject matter of the presently disclosed subject matter;

FIG. 4 illustrates a block diagram of an example pharmaceutical preparation device utilizing imaging-enhanced preparation process component placement, in accordance with an example of the presently disclosed subject matter;

FIG. 5 is a flow diagram of a specific example method of imaging-enhanced preparation process component placement, in accordance with an example of the presently disclosed subject matter;

FIG. 6A is an example 2D precalibration image, in accordance with an example of the presently disclosed subject matter;

FIGS. 6B and 6C are examples of 2D real-time captured images, in accordance with an example of the presently disclosed subject matter; and

FIG. 7 is a flow diagram of a generalized example method of imaging-enhanced preparation process component placement, in accordance with an example of the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “comparing”, “determining”, “calculating”, “receiving”, “providing”, “obtaining”, “detecting” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the processor, mitigation unit, and inspection unit therein disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

It is to be understood herein that although the below examples have been described with reference to the pharmaceutical compounding component being the syringe along with a syringe adaptor/connector, the description below relates to any type of the pharmaceutical compounding components generally described herein above.

It is to be understood herein that although the below examples have been described with reference to the transfer unit TU being a syringe manipulator and the gripper being a gripping arm thereof, the description below relates to any type of the transfer unit and gripper generally described herein above.

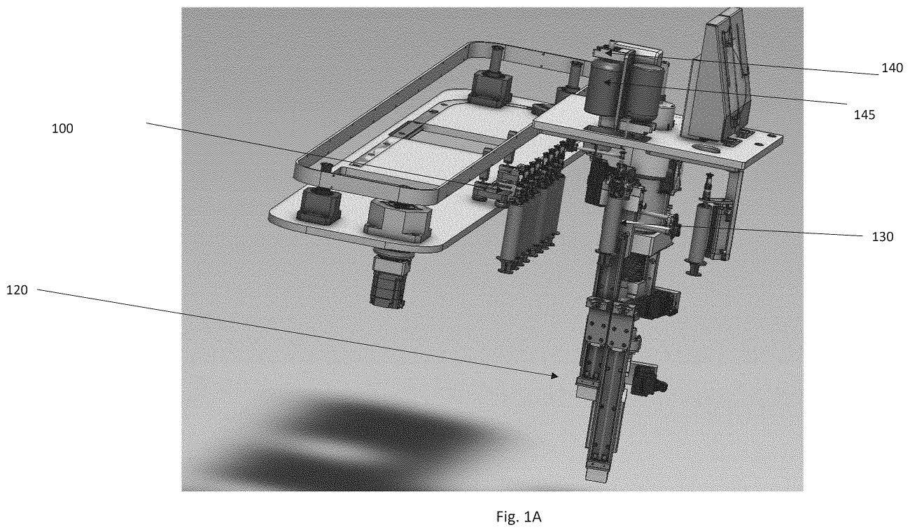

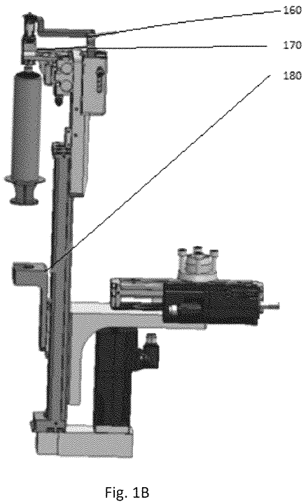

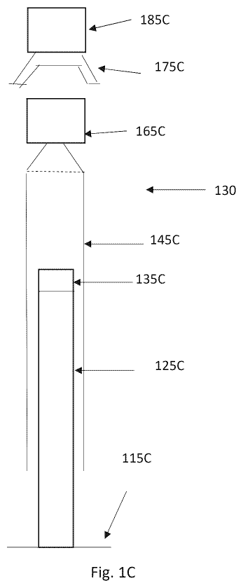

Attention is now directed to FIG. 1A, which illustrates an example pharmaceutical preparation device (PPD), in accordance with some embodiments of the presently disclosed subject matter.

In the illustrated example, the PPD includes a vial holder 140, which is adapted to hold fluid vial 142, which contains fluid that is to be drawn into a syringe 130. The PPD further includes a syringe queue 100 including syringes 130 for use by the PPD, for example, by a syringe transport unit 120 that transports and manipulate the syringes 130.

FIG. 1B illustrates an example transport unit 120 being a syringe manipulator having and engaging arm 160, a gripping arm 170, and plunger arm 180, in accordance with some embodiments of the presently disclosed subject matter. The gripping arm 170 constitutes a gripper configured for grasping a syringe 130, at the syringe connector in the illustrated example. It is to be understood that the gripper can grasp the syringe at any other part thereof, for example the barrel, for the purposes of holding and moving the syringe.

FIG. 1C schematically illustrates an example syringe assembly 130 with associated fluid vial components, in accordance with some embodiments of the presently disclosed subject matter. The syringe assembly includes a plunger flange 115C, a plunger 125C, a syringe piston 135C, syringe barrel 145C, and a syringe connector 165C.

In some examples, the PPD positions the syringe assembly including syringe connector 165C for the purpose of establishing its fluid interconnection with the fluid container adaptor 175C as part of the pharmaceutical preparation process. The fluid container adaptor 175C enables transfer of fluid between the syringe 130 and the fluid container 185C.

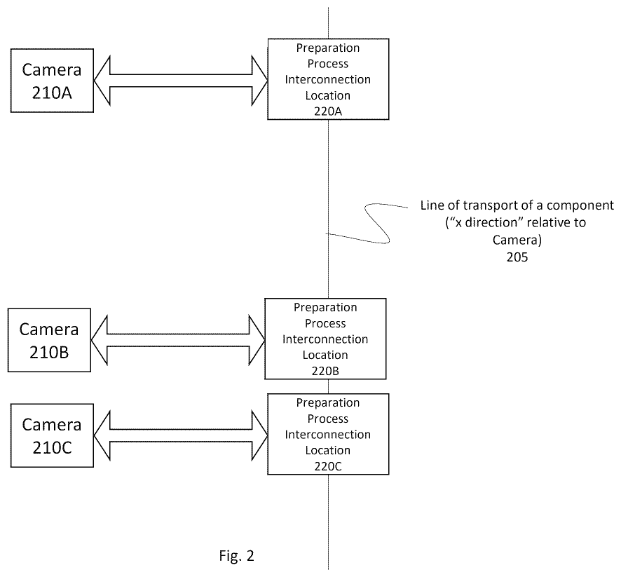

Attention is now directed to FIG. 2, which illustrates a generalized view from above of an example path of a transport unit in a pharmaceutical preparation device (PPD) utilizing imaging-enhanced preparation process component placement, in accordance with some embodiments of the presently disclosed subject matter.

The example PPD transport unit path depicted in FIG. 2 includes several preparation process interconnection locations (PPILs) 220A, 220B, 220C. The term “interconnection location” refers to, at least, a physical location in the PPD where a component used in preparation of a pharmaceutical dose can be placed for a drug preparation operation. In the example of FIG. 2, a transport unit (e.g. a syringe transport unit as described above, conveyor, robot arm etc.) can move a component (e.g. a syringe) along a line 205 between the preparation process interconnection location 220A, preparation process interconnection location 220B, and preparation process interconnection location 220C. At each of these locations, the PPD can perform an operation including transfer of drug.

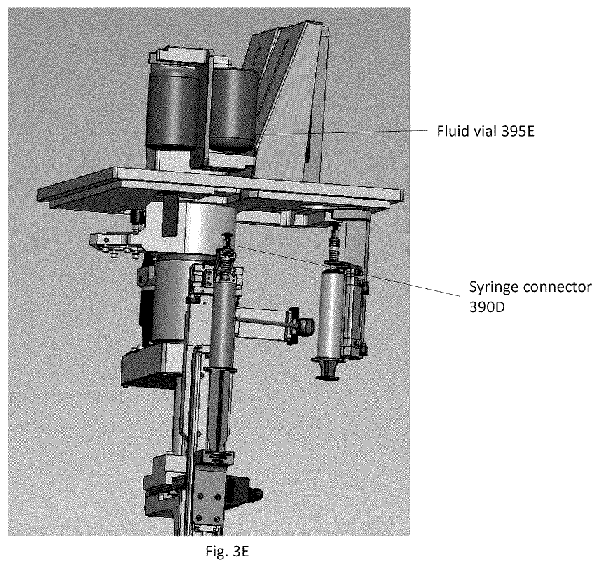

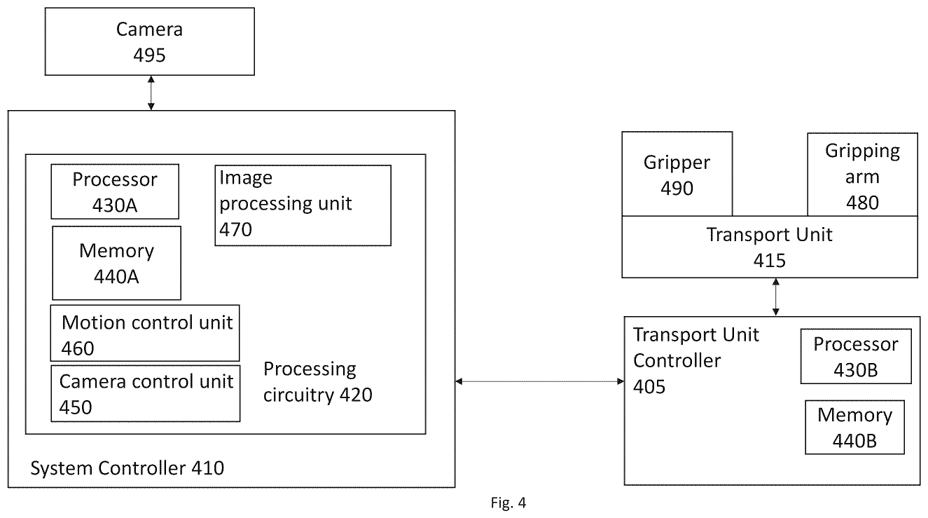

A controller of the transport unit (e.g. as described below with reference to FIG. 4) can include a processing circuitry including a processor and memory, and can be programmed to move the transport unit so that the component is properly positioned (at a desired position) at one of the preparation process interconnection locations 220A, 220B, 220C. In some examples, the transport unit controller maintains data indicative of fixed offsets along the line of transport unit movement 205 that are associated with the PPILs, and then utilizes transport unit servo control or a similar mechanism to move the transport unit by each required distance.

It is noted that in some examples the transport unit is required to transport/move a gripper (as shown below with reference to FIG. 4) to a particular preparation process interconnection location so that the gripper can grasp a component. It is further noted that in some examples the transport unit is required to transport the component grasped by the gripper to a particular preparation process interconnection location so that an operation can be performed using the transported component.

By way of non-limiting example: a transport unit controller can control a transport unit (e.g. syringe transport unit) to move a gripper to a first preparation process interconnection location that is adjacent to a syringe assembly that is in a queue of syringe assemblies. The transport unit controller can then control the transport unit to e.g. extend a gripping arm associated with the gripper and control the gripper to grasp the syringe assembly. Subsequent to the grasping of the syringe assembly, the transport unit controller can control the transport unit to move the gripper to a second preparation process interconnection location which is directly beneath a location where a vial has been placed into a vial holder. The transport unit controller can control the transport unit to move the gripper upward, so as to establish an interconnection between the syringe assembly and a vial adaptor attached to the vial. It is to be understood herein that although the container has been described as being a vial, it can be any container of the containers described herein above.

There can be various causes of error in the placement of the gripper and/or the component grasped by the gripper. For example, the mechanical control (e.g. servo) transporting the gripper can be inexact, or in some cases the exactness of its movements can diminish over time. Additionally, pharmaceutical compounding components (e.g. syringe assembly) can deviate from the precise expected dimensions (or the components may themselves have been assembled imperfectly). Furthermore, a compounding component being grasped by a gripper can be positioned in an imperfect manner. For example: a syringe being grasped by a gripper of a syringe transport unit might be grasped higher or lower than expected, or at angle that deviates from being perfectly in a desired orientation.

In some embodiments of the presently disclosed subject matter, cameras 210A, 210B, 210C can be placed within the PPD to monitor respective preparation process interconnection locations 220A, 220B, 220C. Respective positions of cameras monitoring PPILs are termed PPIL camera locations.

It is noted that cameras 210A, 210B, 210C can actually be other types of imaging devices (e.g. radar or capacitive sensor). In some examples, one or more of cameras 210A, 210B, 210C capture two-dimensional (2D) digital images. In some examples, one or more of cameras 210A, 210B, 210C capture three-dimensional (3D) digital images.

A 2D digital image can include, for example, a grid of pixels of a certain x dimension and y dimension, where each pixel consists of e.g. a greyscale intensity, or a triplet of red, green, and blue intensities. A 3D digital image can additionally include, for example, a distance value associated with each pixel.

In some embodiments of the presently disclosed subject matter, a controller can control one of the cameras to captures images of a respective preparation process interconnection location. As described herein below, the controller can utilize the images and apply methods to identify potential mispositioning or displacement of a gripper or compounding component being grasped by the gripper—and control the transport arm to perform corrective action.

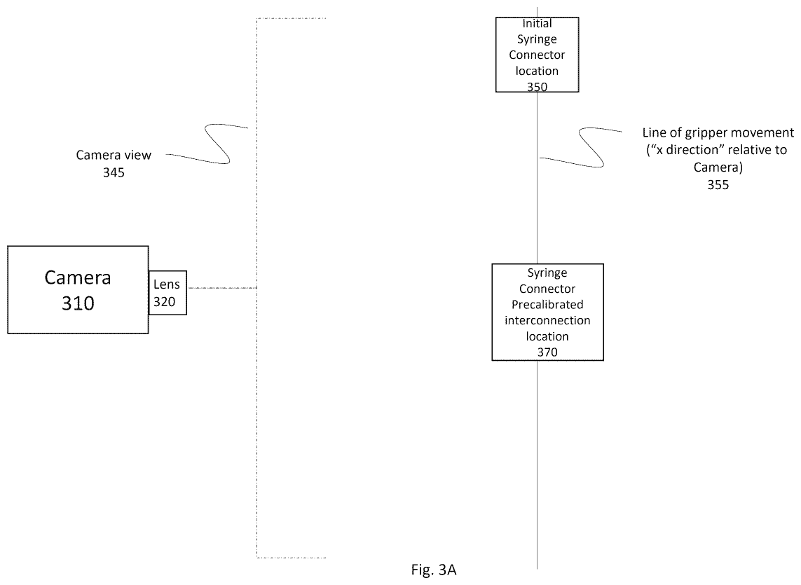

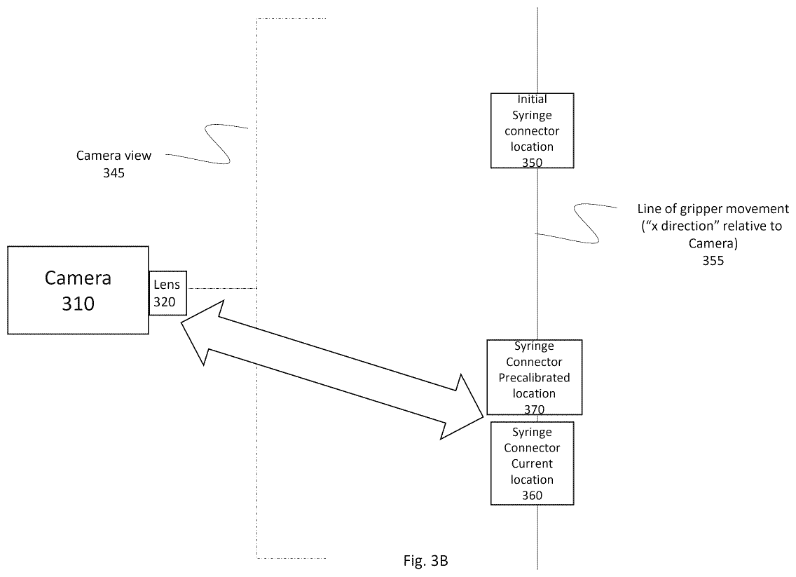

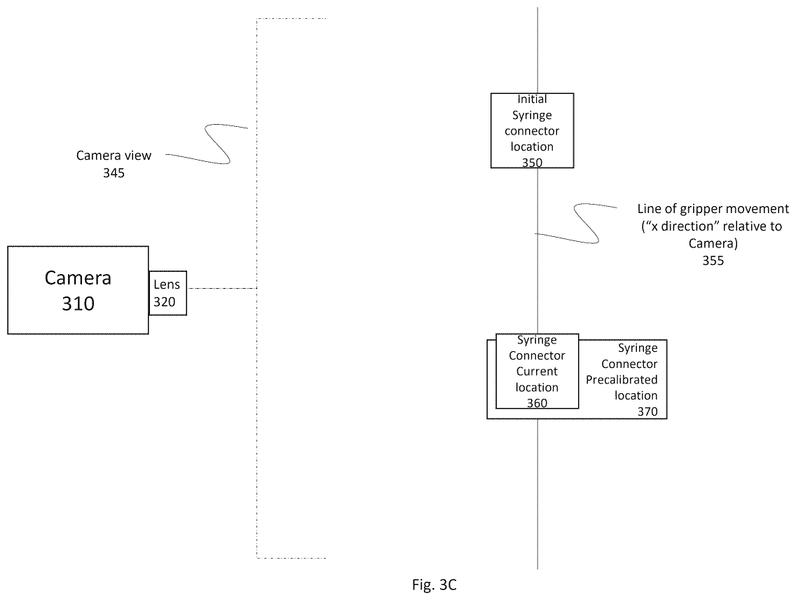

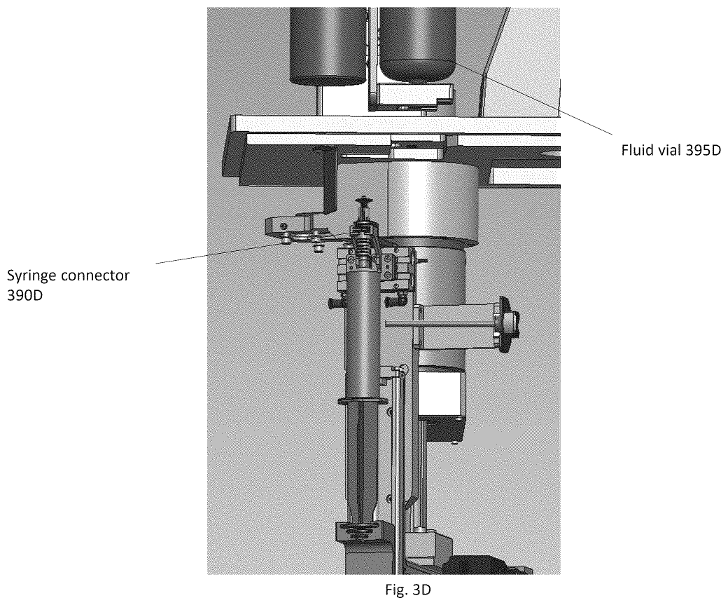

Attention is now directed to FIGS. 3A-3C, which illustrate an example sequence of positioning a syringe assembly, in accordance with some embodiments of the presently disclosed subject matter. It is noted that FIGS. 3A-3C are not drawn to scale.

In FIG. 3A, a syringe connector of a syringe assembly is located at initial syringe connector location 350. Initial syringe connector location 350 can be a location in three-dimensional space and be associated with x, y, and z coordinates. The syringe connector of the syringe assembly can be for example grasped by a syringe gripper, which in turn can be moved by a transport unit that is controlled by a transport unit controller (for example: as shown below with reference to FIG. 4).

Syringe connector precalibrated interconnection location 370, also referred to herein as calibrated position or desired position, is a location within the PPD where the syringe connector is required to be placed for performance of a step of the pharmaceutical preparation. The syringe connector precalibrated interconnection location 370 is co-located or located within a respective pharmaceutical preparation interconnection location (PPIL).

At this stage, a transport unit controller can initiate motion of the gripper in the x direction relative to camera 310 (shown by vertical line 355) and/or in the z direction (i.e. up-and-down movement relative to camera 310, which is not visible in the view from above illustrated in FIG. 3A)—to place the syringe connector at syringe connector precalibrated interconnection location 370. By way of non-limiting example, the transport unit controller might move the gripper 4 centimeters (cm) in the x direction.

Camera 310 (and lens 320) can be directed towards syringe connector precalibrated interconnection location 370 and can capture images of the PPIL and syringe connector precalibrated interconnection location 370.

It is noted that in some embodiments, the gripper can be required to move in the y direction relative to camera 310 (possibly in addition to movement in the x and/or z direction). Movement in the y direction relative to camera 310 can be described as forward-and-backward movement relative to the camera. In some such embodiments, a second camera is placed (e.g. in a position 90 degrees from the first camera to monitor this movement). In some other embodiments, camera 310 can be a 3D camera with 3D imaging capabilities as described above.

FIG. 3B illustrates a scenario where the transport unit controller has moved the syringe connector to position the syringe connector at the required location for the next pharmaceutical preparation step (i.e. 4 cm in the x direction). In this example, the syringe assembly is placed at syringe connector current location 360, also referred to herein as current position, (i.e. with a certain x direction displacement from the target/desired location) due to e.g. inexact placement by a servo mechanism of the transport unit, or due to the gripper gripping the syringe with a certain displacement etc.

Camera 310 can capture an image of syringe connector precalibrated location 370 or the corresponding PPIL, and the image can include syringe connector current location 360. Camera 310 can capture the image responsive to e.g. an instruction from a controller that is controlling a pharmaceutical preparation process, or responsive to instruction from a local controller that captures images e.g. periodically.

A process controller (for example) can receive the captured image, and perform image processing and analysis techniques as described in detail hereinabove in the section general description with reference to determining a distance and direction in the x and/or z direction for improved (e.g. optimal) placement of the syringe connector at the desired position. In some embodiments, the controller can also (or exclusively) determine a distance and direction in the y direction (relative to the camera). The process controller (for example) can then control e.g. the transport unit controller to move the gripper in accordance with this determined distance and direction in x, y, and/or z directions.

FIG. 3C illustrates an example result of the second movement of the transport unit controller: syringe connector current location 360 is aligned with syringe connector precalibrated interconnection location 370 in the x direction (as visible) and the in the z direction (not visible). In this manner, the step in the pharmaceutical preparation process (e.g. establishing interconnection between the syringe connector and a vial adaptor) can be performed successfully even e.g. in presence of inexact movements of the transport unit, deviations in measurements of syringe assembly components, variations in the position orientation of the syringe in the gripper etc.

FIG. 3D illustrates a side view of a PPD wherein the syringe assembly is inexactly placed, according to some embodiments of the presently disclosed subject matter.

In FIG. 3D, syringe connector 390D is to the left of opening of the fluid vial 395D. This is similar to the arrangement shown in FIG. 3B above prior to the imaging-based placement of the syringe.

FIG. 3E illustrates a side view of a PPD wherein the syringe assembly is correctly placed, according to some embodiments of the presently disclosed subject matter.

In FIG. 3E, syringe connector 390D is beneath the opening of the fluid vial 395D. This is similar to the arrangement shown in FIG. 3C above after the imaging-based placement of the syringe.

Attention is now directed to FIG. 4, which is a block diagram of an example PPD utilizing imaging-enhanced preparation process component placement, in accordance with some embodiments of the presently disclosed subject matter.

System controller 410 can be a controller which controls PPD components for execution of all or part of a pharmaceutical preparation process. System controller 410 can include a processing circuitry 420, which in turn can include processor 430A and memory 440A. System controller 410 can be operably connected to camera 495 and transport unit controller 405.

Processor 430A can be a suitable hardware-based electronic device with data processing capabilities, such as, for example, a general purpose processor, digital signal processor (DSP), a specialized Application Specific Integrated Circuit (ASIC), one or more cores in a multicore processor, etc. Processor 430A can also consist, for example, of multiple processors, multiple ASICs, virtual processors, combinations thereof etc.

Memory 440A can be, for example, a suitable kind of volatile and/or non-volatile storage, and can include, for example, a single physical memory component or a plurality of physical memory components. Memory 440A can also include virtual memory. Memory 440A can be configured to, for example, store various data used in computation.

Processing circuitry 420 can be configured to execute several functional modules in accordance with computer-readable instructions implemented on a non-transitory computer-readable storage medium. Such functional modules are referred to hereinafter as comprised in the processing circuitry. These modules can include, for example, camera control unit 450, motion control unit 460, and image processing unit 470.

Camera control unit 450 can control image capture by camera 495, and can receive captured image data from camera 495.

Motion control unit 460 can control movement of components of the PPD and received data about such movements, for example by communicating with transport unit controller 405.

Image processing unit 470 can perform image processing on captured images, and can also perform analysis to determine directions and associated distances required to move e.g. a transport unit.

Transport unit controller 405 can include processor 430b and memory 440b. Transport unit controller 405 can be operably connected to transport unit 415, and exchange commands and/or status information.

Transport unit 415 can be an assemblage that includes gripping arm 480, gripper 490, and/or other movable parts, and can actuate movement of those parts (for example: in response to commands from transport unit controller 405)

In some embodiments, transport unit 415 is a syringe transport unit as described above with reference to FIGS. 1B-1C. In some other embodiments, transport unit 415 is a different mechanism for grasping, moving, and releasing components (e.g. Selective Compliance Assembly Robot Arm (SCARA) etc.)

It is noted that in some embodiments transport unit controller 405 can be incorporated into system controller 410, so that, for example, system controller 410 can directly control and/or receive status information from physical components such as gripping arm 480 and gripper 490.

It is noted that the teachings of the presently disclosed subject matter are not bound by the entities described with reference to FIG. 4. Equivalent and/or modified functionality can be consolidated or divided in another manner and can be implemented in any appropriate combination of software with firmware and/or hardware and executed on a suitable device. The system controller and transport unit controller can be a standalone network entity, or integrated, fully or partly, with other entities. It will be clear to one skilled in the art how a control system can be employed in other embodiments.

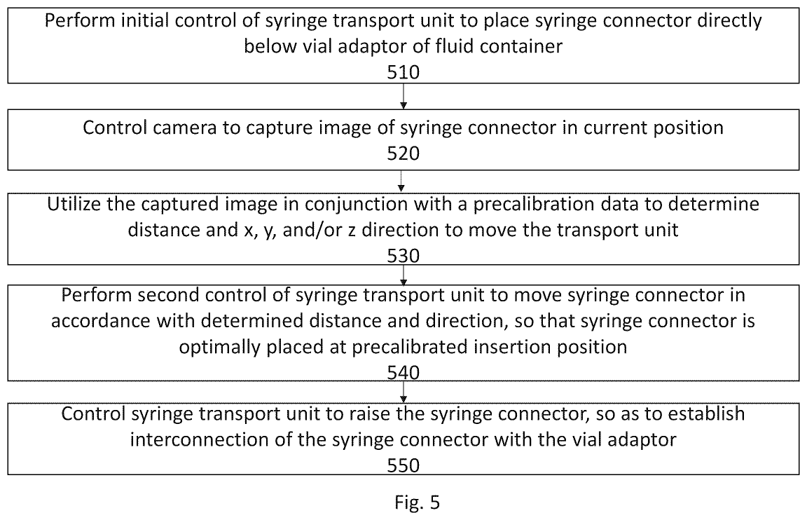

Attention is now directed to FIG. 5, which illustrates a flow diagram of an example method of imaging-enhanced preparation process component placement in a pharmaceutical preparation device (PPD), in accordance with some embodiments of the presently disclosed subject matter.

Processing circuitry 420 (e.g. motion control unit 460) can perform 510 initial control of transport unit 415 (e.g. via transport control unit 405) so as to initiate motion of syringe connector 165C from, for example, initial syringe connector location 350 to syringe connector precalibrated interconnection location 370. In the example method illustrated in FIG. 5, syringe connector precalibrated interconnection location 370 can be directly beneath fluid container adapter 175C.

Next, processing circuitry 420 (e.g. camera control unit 450) can next control 520 camera 495 to capture in real time (during use of the PPD) an image of syringe connector 165C in its current position. In some examples, the captured image is a 2D image. In some other examples the captured image is a 3D image, which can include distance information associated with each pixel, as described above.

Processing circuitry 420 (e.g. image processing unit 470) can then utilize 530 the captured image in conjunction with e.g. a precalibration data to determine a distance and direction for moving the transport unit 415 so that syringe connector 165C is positioned directly below fluid container adaptor 175C i.e. ready for establishing interconnection therewith.

In some cases, the precalibration data can include two-dimensional (2D) or three-dimensional (3D) precalibration image(s) depicting the gripper and/or the syringe in a calibrated position (also referred to herein as desired position), as captured by the camera from the PPIL camera location. Once the image of the PPIL capture in step 520 is obtained, the processing circuitry, based on the precalibration image(s) and the captured (real-time) image(s), for example analysing the pixel shift therebetween, determines whether the gripper and/or the syringe is in the desired position or not, and if not then determine a distance and direction for moving the transport unit 415 so that syringe connector 165C is positioned directly below fluid container adaptor 175C, i.e., in the desired position.

In some cases, the precalibration data can include a calibration transformation matrix which is derivative of a calibration process utilizing at least three images depicting the gripper and/or the syringe from the PPIL camera location, the calibration transformation matrix being adapted to convert x, y, and/or z coordinates of an image to corresponding coordinates in a transport unit frame-of-reference. It is to be understood herein that all the description provided above in general description with respect to the calibration transformation matrix applies to step 530. The calibration transformation matrix can be derived, for example, as described in Joochim et. al. “The 9 Points Calibration Using SCARA Robot” (https://ieeexplore.ieee.org/abstract/document/8999901).

In some examples, the precalibration data can also include the desired position of the gripper and/or the syringe in the PPIL, in the transport unit frame of reference (TUFoR), and accordingly, the processing circuitry can have the desired coordinates (in the TUFoR), i.e., the coordinates of position where the gripper and/or the syringe is required/desired to be positioned.

When the captured image is a 2D image, processing circuitry 420 (e.g. image processing unit 470) can determine a direction of movement in x and/or z directions as described above with respect to FIGS. 3A-3D.

When the captured image is a 3D image, processing circuitry 420 (e.g. image processing unit 470) can determine a direction including movement in x, y, and/or z directions.

In some other embodiments, processing circuitry 420 (e.g. image processing unit 470) determines distance and direction of the transport unit 415 movement from the 2D or 3D captured image and precalibration image in a different suitable manner.

It is noted that precalibration images can be acquired during a “calibration phase” when initializing or first using a PPD e.g. a syringe can be manually or mechanically positioned at syringe connector precalibrated interconnection location 370, and a precalibration image can then be captured.

Similarly, in some examples, a PPD may facilitate capturing e.g. two 2D or three 3D images of the PPIL where syringe connector 165C is placed with a known deviation from the correct position. System controller 410 can then determine pixel-to-distance values based on the images and the known deviations from the correct/desired position.

Processing circuitry 420 (e.g. motion control unit 460) can next perform 540 a control of syringe transport unit 415 to move it in accordance with the determined distance and direction e.g. so that a syringe connector 165C is directly below a fluid container adaptor 175C, i.e., in the desired position.

Processing circuitry 420 (e.g. motion control unit 460) can control 550 transport unit 415 to raise syringe connector 165C so as to establish interconnection of the syringe connector 165C with fluid container adaptor 175C.

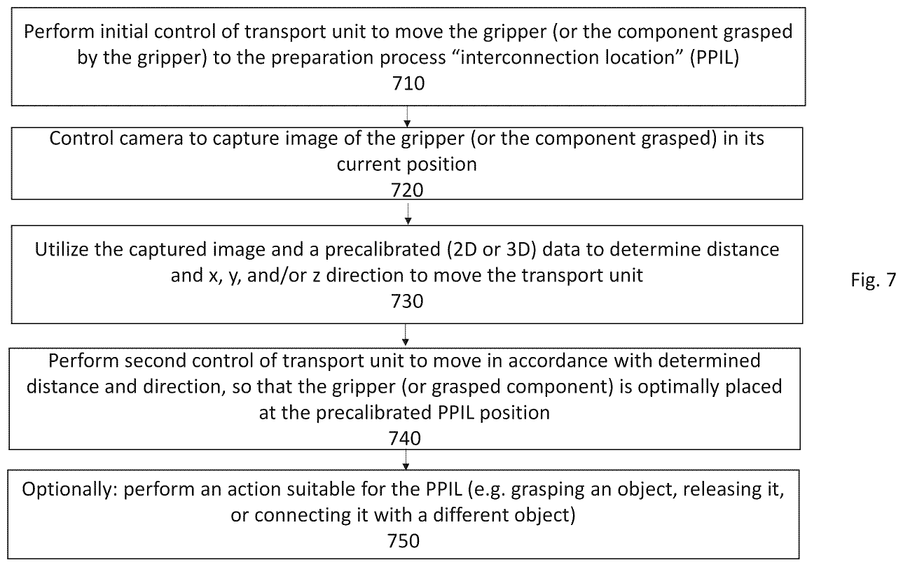

It is noted that the teachings of the presently disclosed subject matter are not bound by the flow charts illustrated in FIGS. 5 and 7. The illustrated operations can occur out of the illustrated order. It is also noted that whilst the flow chart is described with reference to elements of the system of FIGS. 1A-1C and FIG. 4, this is by no means binding, and the operations can be performed by elements other than those described herein.

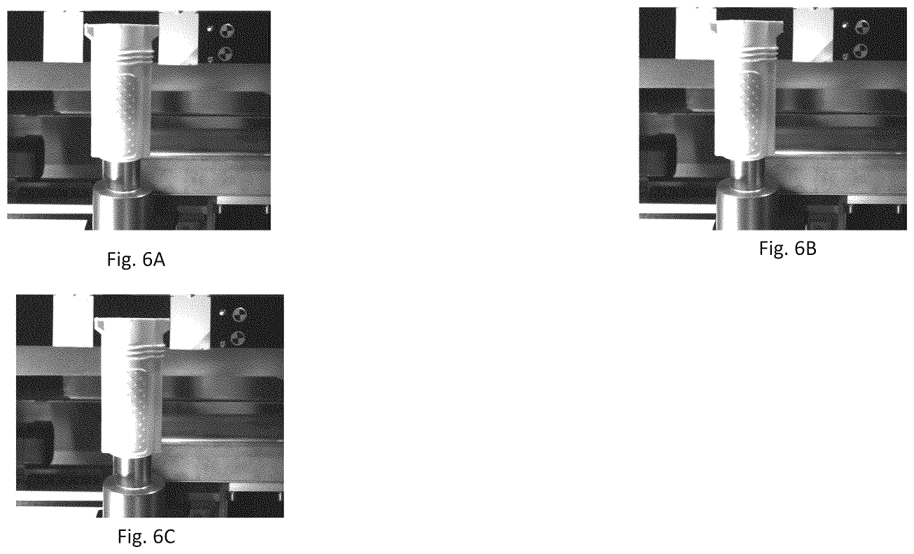

FIG. 6A is an example 2D “precalibration image”, according to some embodiments of the presently disclosed subject matter.

FIG. 6A depicts a syringe assembly attached to a syringe connector 165C. Syringe connector 165C is positioned at an optimal location and orientation, i.e., the desired position.

FIG. 6B-6C are examples of 2D captured images, according to some embodiments of the presently disclosed subject matter. FIG. 6B is an image of the syringe connector 165C with a deviation in the x direction. Similarly, FIG. 6C is an example image of the syringe connector 165C with a deviation in the z direction.

It is noted that in some examples, a precalibration image will depict the gripper 490 in the position that is required to be in prior to the beginning of gripping. In such examples, captured digital images can include gripper 490, and the system controller's computation of direction and distance can utilize pixel offsets of the gripper etc.

Attention is now directed to FIG. 7, which illustrates a flow diagram of a generalized example method of imaging-enhanced preparation process component placement in a pharmaceutical preparation device (PPD), in accordance with some embodiments of the presently disclosed subject matter.

The method described in FIG. 7 is applicable both to properly position a gripper (e.g., in order to grasp an object) as well as to properly position a grasped object such as a pharmaceutical preparation component.

Processing circuitry 420 (e.g. motion control unit 460) can perform 710 initial control of transport unit 415 (e.g. via transport control unit 405) to move transport unit 415 from an initial location to position gripper 490 or a component grasped by the gripper 490 at a preparation process interconnection location (PPIL).

Next, processing circuitry 420 (e.g. camera control unit 450) can control 720 a camera to capture in real time (during use of the PPD) an image of the gripper 490 (or a component grasped by the gripper 490) in its current position. In some examples, the captured image is a 2D image. In some other examples the captured image is a 3D image, which can include distance information associated with each pixel, as described above.

Processing circuitry 420 (e.g. image processing unit 470) can then utilize 730 the captured image in conjunction with e.g. a precalibration data to determine distance and direction for moving transport unit 415 so that the gripper 490 (or a component grasped by the gripper 490) is positioned at the PPIL and is e.g. ready for use in pharmaceutical preparation. It is to be understood herein that all the description with respect to the precalibration data provided herein above, in the general description or in reference to step 530, applies to step 730 as well.

Processing circuitry 420 (e.g. motion control unit 460) can perform 740 a second control of transport unit 415 to move gripper 490 (or a component grasped by the gripper 490) by the determined distance and direction, thereby resulting in correct placement of gripper 490 (or a component grasped by the gripper 490) at the PPIL, for example in the desired position.

Processing circuitry 420 (e.g. motion control unit 460) can perform 750 an action associated with the PPIL e.g. control the transport unit 415 to:
grasp a component in the gripper 490,
release a component from grasp of the gripper 490,
establishing a fluid communication between a component held in gripper 490 to another component.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the presently disclosed subject matter may be, at least partly, implemented on a suitably programmed computer. Likewise, the presently disclosed subject matter contemplates a computer program being readable by a computer for executing the method of the presently disclosed subject matter. The presently disclosed subject matter further contemplates a non-transitory computer-readable memory tangibly embodying a program of instructions executable by the computer for executing the method of the presently disclosed subject matter.

Those skilled in the art will readily appreciate that various modifications and changes can be applied to the embodiments of the presently disclosed subject matter as hereinbefore described without departing from its scope, defined in and by the appended claims.

It is to be understood herein that the examples described in this description (with reference to the drawings and otherwise) have been described with reference to only a few components of the pharmaceutical preparation devices out of all which are encompassed by the scope of the presently disclosed subject matter for the purposes of conciseness and clarity of the present description. Various examples analogous to those described herein with different components of the pharmaceutical preparation devices and with different robotic stations, should be considered within the scope of the present description.

1. A pharmaceutical preparation device (PPD) with imaging-enhanced preparation process component placement, comprising:
a camera configured to capture images of a pharmaceutical preparation interconnection location (PPIL) from a PPIL camera location, said PPIL being associated with precalibration data comprising an image of the PPIL, the image including a location of the PPIL at which the PPD (1) positions and (2) establishes interconnections between pharmaceutical compounding components for transfer of fluid therebetween;
a transport unit (TU) comprising a gripper for grasping a pharmaceutical compounding component, the TU being configured to move at least the gripper in one or more of x, y, and/or z directions in response to control signals; and
the precalibration data also including a precalibration image depicting a calibration pharmaceutical compounding component grasped by the gripper of the TU, in a calibrated position, as captured by the camera from the PPIL camera location, the TU being offset from a position to which the PPD moves the TU to establish the interconnections;
a processing circuitry operably connected to the TU and to the camera, the processing circuitry being configured to:
receive at least one real-time digital image, captured by the camera from the PPIL camera location, the received digital image depicting a pharmaceutical compounding component grasped by the gripper, in a current position in the PPIL;
determine a direction and distance of TU movement based on at least the received real-time digital image and the precalibration data; and
control, via the control signals, the TU to move the gripper in the determined direction by the determined distance;
wherein the direction and distance of TU movement are determined to establish, within the PPIL, an interconnection of the pharmaceutical compounding component grasped by the gripper of the TU with a second pharmaceutical compounding component, the interconnection forming a secured coupling for fluid transfer of pharmaceutical materials therebetween; and
wherein the direction and distance of TU movement are determined utilizing identification information related to identification of the second pharmaceutical compounding component that the interconnection of the pharmaceutical compounding component is to be established with.

2. The PPD of claim 1, wherein the received digital image is two-dimensional (2D), and wherein the determined direction comprises x direction and/or z direction.

3. The PPD of claim 1, wherein the received digital image is three-dimensional (3D), and wherein the determined direction comprises x direction, y direction, and/or z direction.

4. The PPD of claim 1, wherein the precalibration image includes a two-dimensional (2D) or three-dimensional (3D) precalibration image.

5. The PPD of claim 4, wherein the processing circuitry is further configured to, prior to determining the direction and distance of TU movement, determine that there is a pixel shift between the current position and the calibrated position.

6. The PPD of claim 5, wherein the processing circuitry is configured to determine the direction and distance of TU movement based at least on the pixel shift.

7. The PPD of claim 1, wherein the precalibration data includes a calibration transformation matrix which is derivative of a calibration process utilizing at least three images depicting the gripper of the TU and/or the pharmaceutical compounding component grasped by the gripper from the PPIL camera location, the calibration transformation matrix being adapted to convert x, y, and/or z coordinates of an image to corresponding coordinates in a transport unit frame-of-reference.

8. The PPD of claim 7, wherein the processing circuitry is configured to determine the direction and distance of TU movement at least by applying the calibration transformation matrix to the received real-time digital image.

9. The PPD of claim 7, wherein the received digital image is two-dimensional (2D), and the precalibration data includes a calibration transformation matrix which is derivative of a calibration process utilizing at least three images depicting the gripper of the TU and/or the pharmaceutical compounding component grasped by the gripper from the PPIL camera location.

10. The PPD of claim 7, wherein the received digital image is three-dimensional (3D), and the precalibration data includes a calibration transformation matrix which is derivative of a calibration process utilizing at least four images depicting the gripper of the TU and/or the pharmaceutical compounding component grasped by the gripper from the PPIL camera location.

11. The PPD of claim 7, wherein the processing circuitry is configured to perform said calibration process.

12. The PPD of claim 1, wherein the processing circuitry is further configured to control the gripper of the TU to perform at least one of:
grasping said pharmaceutical compounding component;
releasing said pharmaceutical compounding component that the gripper is grasping.

13. A processing circuitry-based method of imaging-enhanced preparation process component placement in a pharmaceutical preparation device (PPD), the method comprising:
utilizing a transport unit (TU) configured to move at least a gripper thereof in one or more of x, y, and/or z directions in response to control signals;
utilizing precalibration data comprising an image of a pharmaceutical preparation interconnection location (PPIL), the image including a location of the PPIL at which the PPD (1) positions and (2) establishes interconnections between pharmaceutical compounding components for transfer of fluid therebetween;
the image of the precalibration data depicting a calibration pharmaceutical compounding component grasped by the gripper of the TU, in a calibrated position, as captured by a camera from located at a PPIL camera location, the TU being offset from a position to which the PPD moves the TU to establish the interconnections;
receiving at least one real-time digital image of the PPIL captured by said camera positioned at said PPIL camera location, the received digital image depicting the gripper of the TU and/or a pharmaceutical compounding component grasped by the gripper in a current position;
determining a direction and distance of TU movement, based on at least the received real-time digital image and the precalibration data; and
controlling the TU to move the gripper in the determined direction by the determined distance;
wherein the direction and distance of TU movement are determined to establish, within the PPIL, an interconnection of the pharmaceutical compounding component grasped by the gripper of the TU with a second pharmaceutical compounding component, the interconnection forming a secured coupling for fluid transfer of pharmaceutical materials therebetween; and
wherein the direction and distance of TU movement are determined utilizing identification information related to identification of the second pharmaceutical compounding component that the interconnection of the pharmaceutical compounding component is to be established with.

14. The method of claim 13, wherein the precalibration data image comprises a two-dimensional (2D) or three-dimensional (3D) precalibration image.

15. The method of claim 14, further comprises, prior to determining the direction and distance of TU movement, determining that there is a pixel shift between the current position and the calibrated position.

16. The method of claim 15, comprises determining the direction and distance of TU movement based at least on the pixel shift.

17. The method of claim 13, wherein the precalibration data includes a calibration transformation matrix which is derivative of a calibration process utilizing at least three images depicting the gripper of the TU and/or the pharmaceutical compounding component grasped by the gripper from the PPIL camera location, the calibration transformation matrix being adapted to convert x, y, and/or z coordinates of an image to corresponding coordinates in a transport unit frame-of-reference.

18. The method of claim 17, comprises determining the direction and distance of TU movement at least by applying the calibration transformation matrix to the received real-time digital image.

19. The method of claim 18, further comprises performing said calibration process.

20. A computer program product comprising a computer readable non-transitory storage medium containing program instructions, which program instructions when read by a processor, cause the processing circuitry to perform a method of imaging-enhanced preparation process component placement in a pharmaceutical preparation device (PPD), the method comprising:
utilizing a transport unit (TU) configured to move at least a gripper thereof in one or more of x, y, and/or z directions in response to control signals;
utilizing precalibration data comprising an image of a pharmaceutical preparation interconnection location (PPIL), the image including a location of the PPIL at which the PPD (1) positions and (2) establishes interconnections between pharmaceutical compounding components for transfer of fluid therebetween;
the image of the precalibration data depicting a calibration pharmaceutical compounding component grasped by the gripper of the TU, in a calibrated position, as captured by a camera from located at the PPIL camera location, the TU being offset from a position to which the PPD moves the TU to establish the interconnections;
receiving at least one real-time digital image of the PPIL captured by a camera positioned at a PPIL camera location, the received digital image depicting the gripper of the TU and/or a pharmaceutical compounding component grasped by the gripper in a current position;
determining a direction and distance of TU movement, based on, at least the received real-time digital image and the precalibration data; and
controlling the TU to move the gripper in the determined direction by the determined distance;
wherein the direction and distance of TU movement are determined to establish, within the PPIL, an interconnection of the pharmaceutical compounding component grasped by the gripper of the TU with a second pharmaceutical compounding component, the interconnection forming a secured coupling for fluid transfer of pharmaceutical materials therebetween; and
wherein the direction and distance of TU movement are determined utilizing identification information related to identification of the second pharmaceutical compounding component that the interconnection of the pharmaceutical compounding component is to be established with.

21. The computer program product of claim 20, wherein the precalibration data image comprises a two-dimensional (2D) or three-dimensional (3D) precalibration image.

22. The computer program product of claim 21, wherein the method further comprises, prior to determining the direction and distance of TU movement, determining that there is a pixel shift between the current position and the calibrated position.

23. The computer program product of claim 22, wherein the method further comprises determining the direction and distance of TU movement based at least on the pixel shift.

24. The computer program product of claim 20, wherein the precalibration data includes a calibration transformation matrix which is derivative of a calibration process utilizing at least three images depicting the gripper of the TU and/or the pharmaceutical compounding component grasped by the gripper from the PPIL camera location, the calibration transformation matrix being adapted to convert x, y, and/or z coordinates of an image to corresponding coordinates in a transport unit frame-of-reference.

25. The computer program product of claim 24, wherein the method comprises determining the direction and distance of TU movement at least by applying the calibration transformation matrix to the received real-time digital image.

26. The computer program product of claim 24, wherein the method further comprises performing said calibration process.
